(19) United States
(12) Patent Application Publication
(10) Pub. No.: US 2003/0233415 A1
(43) Pub. Date: Dec. 18, 2003

(54) Apparatus and method for private online message center

(75) Inventor: William J. Beyda, Cupertino, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information and Communication Networks, Inc.

(21) Appl. No.: 10/174,013

(22) Filed: Jun. 17, 2002

(51) Int. Cl. G06F 15/16

(52) U.S. Cl. 709/206; 709/203

(57) ABSTRACT

An apparatus and method are provided for a user to create a temporary e-mail address to which the user's mail can be addressed. The mail is then forwarded to the user's permanent e-mail address. The forwarding can be customized. In one embodiment, the temporary address expires after a predetermined amount of time has elapsed. In an alternative, after time-out, the forwarding expires.

### FIELD OF THE INVENTION

The invention relates to e-mail and voicemail messages and mailboxes.

### BACKGROUND OF THE INVENTION

Millions of people now send and receive e-mail and/or voicemail through work, school, or online services. Many online services offer the option of private mailboxes for sending and receiving private e-mail and voice mail correspondence. Many people find themselves receiving more e-mail messages than they can conveniently read. The prevalence of annoying junk mail (“spam”) has aggravated the problem. As a result, people are becoming reluctant to publicly disseminate their e-mail addresses.

A single user of an online service can create separate private mailboxes. For example, America Online (AOL) allows a single subscriber to create five separate e-mail mailboxes, allowing the user to manage transactions or screen personae separately. However, managing these separate accounts becomes burdensome, and there is a limit to the number of mailboxes that a user wants to manage. What is needed is an apparatus and method that allows a user conveniently to conduct internet transactions without revealing his permanent e-mail address.

### SUMMARY OF THE INVENTION

This invention allows for temporary creation of a private message store, but with a set time expiration and rules appropriate to the type of communication involved.

A user with a permanent e-mail address can set up a temporary e-mail address through a web site or server. (In an alternative, instead of “permanent” and “temporary” e-mail addresses, a primary and secondary address can be set up at different times or at the same time.) Mail addressed to the temporary address is forwarded to the user's permanent e-mail address. The forwarding can be customized so that only messages with a certain code, such as a re line or heading, are forwarded to the permanent address. The forwarding can also have a time expiration and can be combined with other forwarding or notification mechanisms, such as “urgent” notification. In alternatives, the messages are stored instead of forwarded.

### BRIEF DESCRIPTION OF THE DRAWINGS

FIG. 1 is a general depiction of an Internet e-mail system of the background art.

FIG. 2 generally illustrates an Internet e-mail system in accordance with the present invention.

FIG. 3 generally illustrates an alternative Internet e-mail system in accordance with the present invention.

FIG. 4 is a flow chart illustrating steps of a method of a preferred embodiment of the present invention.

FIGS. 4A and 4B are flow charts illustrating substeps of the method of FIG. 4.

FIG. 5 is a flow chart illustrating substeps of a method of a preferred embodiment.

### DETAILED DESCRIPTION OF THE PREFERRED EMBODIMENTS

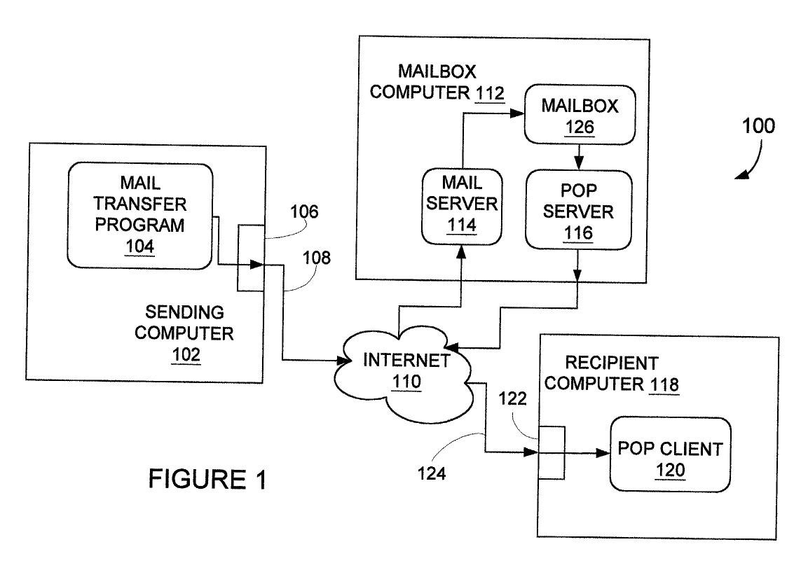

FIG. 1 depicts a dialup e-mail system 100 using a Post Office Protocol (POP) system. A sending computer 102 includes a mail program 104. Computer 102 connects through a modem 106 to a telephone line 108, and then to the Internet 110. A mailbox computer 112 includes two servers, a mail server 114 and a POP server 116, and connects to the Internet. A recipient's computer 118 runs an e-mail program 120 that can become a client of POP server 116, and connects via a modem 122 and telecommunications line 124 to the Internet 110.

To send an e-mail message, the sending computer's mail transfer program 104 forms a dial-up connection through modem 106 and sends the message through the mail server 114 using the SMTP protocol. Mail server 114 accepts messages from arbitrary senders, and transfers the message to the recipient's mailbox 126. (Recipient's mailbox 126 is in mailbox computer 112, which continuously runs a mail server.)

To retrieve a message, the recipient can use recipient's computer 118 to form a dialup connection via modem 122 and telecommunications line 124. Recipient's computer 118 runs e-mail software 120 that becomes a client of POP server 116, and can then access recipient's mailbox 126 via the Internet 110. Typically, the recipient can use an arbitrary computer because access to the POP server is allowed only after entry of a password or other user authentication. In addition to e-mail retrieval, the POP server conventionally provides information about mailbox contents.

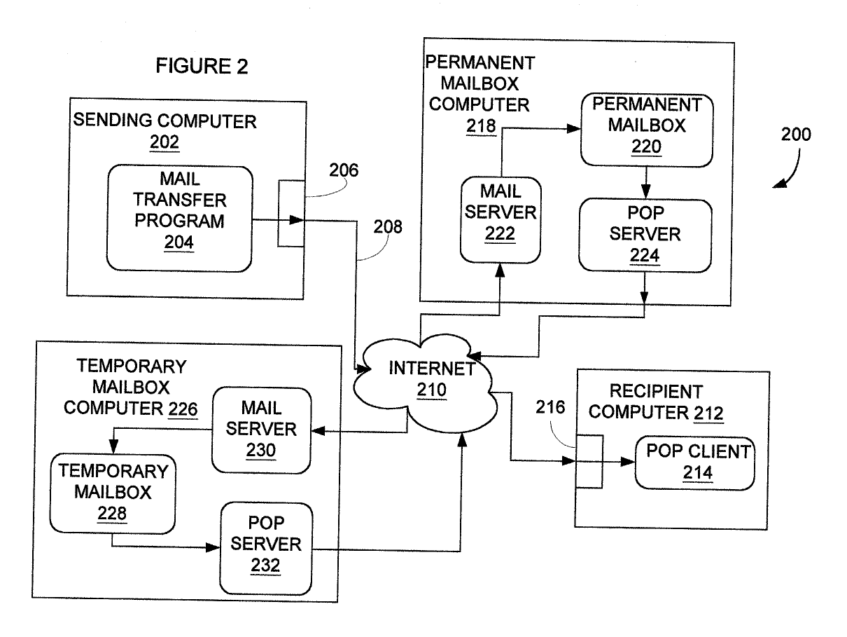

FIG. 2 shows a dial-up email system 200 in accordance with the present invention. A sending computer 202 includes a mail transfer program 204 and a modem 206. Sending computer 202 connects via telecommunications line 208 to the Internet 210. Also connected to Internet 210 is a recipient computer 212, which runs an e-mail program 214 and includes modem 216.

The system also includes a permanent-mailbox computer 218 including the recipient's permanent e-mail mailbox 220 along with a mail server 222 and a POP server 224, and a temporary-mailbox computer 226 including a temporary mailbox 228, a mail server 230, and a POP server 232. Computers 218 and 226 are also connected to the Internet 210.

System 200 allows a user, in this example, the recipient, more efficiently to manage her e-mail correspondence. In system 200, permanent mailbox computer 218 and the recipient's permanent mailbox 220 are provided by the recipient's Internet Service Provider (ISP). Alternatively, computer 218 and permanent mailbox 220 can be provided by the recipient's employer or another provider.

Temporary mailbox computer 226 and temporary mail box 228 are provided by an alternative mail service. The recipient registers with the alternative mail service and is given an alternative, temporary e-mail address and mailbox and a password to access the mailbox. For example, the alternative mail service might have a domain name such as tempmail.com, and the recipient might get a temporary e-mail address that looks something like carseller@tempmail.com. In a preferred embodiment, the recipient specifies a time limit after which the temporary address will expire; or, alternatively, the recipient can maintain the temporary mailbox indefinitely but specify a temporary time period for which the service will automatically forward incoming e-mail to a permanent e-mail mailbox. In another alternative, the recipient can activate the temporary mailbox for an indefinite period of time but the mailbox is automatically canceled upon the occurrence of a condition, for example, if the car is sold.

In an example, imagine that recipient has placed a want ad in the local newspaper offering a used car for sale. Instead of providing her address or telephone number in the ad, she provides her temporary e-mail address.

A person responding to the e-mail recipient's ad uses computer 202 to connect to the Internet 210 via modem 206 and telecommunications line 208 and sends an e-mail message addressed to the temporary mailbox. The e-mail message is sent to mail server 230, which accepts mail from arbitrary computers, and stored in temporary mailbox 228. The message can be retrieved by the user from the user's own computer, or from an arbitrary computer. The alternative mail service can forward the e-mail to the user's permanent computer or to an arbitrary computer designated by the user.

Dial-up connections have been used throughout this application for illustrative purposes. A dial-up connection using a modem to reach the Internet is just one method of attaching. There are many other methods for users to reach the Internet, including, but not limited to, ISDN lines, DSL lines, cable modems, T-1 lines, and LAN connections at work. The method of attachment to the Internet is not critical to this invention.

Similarly, the system has been illustrated with reference to mail servers using POP/SMTP. While SMTP is most likely to be the protocol used between mail servers and external correspondents, these are only exemplary. The invention is compatible with the use of any mail protocols on any of the connections, e.g., Microsoft Outlook/Exchange and/or Lotus Notes/Domino.

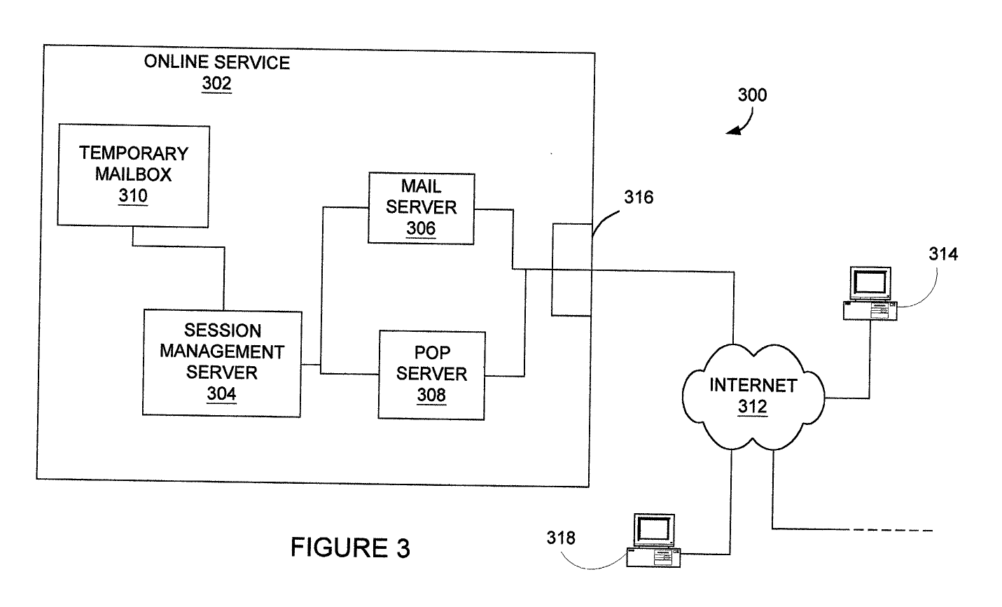

In another embodiment, an on-line service manages the temporary mailbox. The online service can include but is not limited to on-line auctions, shopping sites, social and game sites, and bulletin boards. A temporary mailbox system 300 administered by an on-line service is illustrated in FIG. 3.

System 300 includes an online service 302 that includes a Session Management Server (SMS) 304, a mail server 306, a POP server 308, and a temporary mailbox 310. Online service 302 can be any kind of site that a user can access from the Internet. For example, auction sites such as eBay.com, multipurpose sites such as Yahoo.com, Internet retailers such as Amazon.com, message boards and bulletin boards, social clubs such as chessclub.com, and university websites are just a few examples of online services. Online services also include Internet Service Providers (ISPs), which have previously been discussed in conjunction with FIG. 2, so they will not be covered here.

Online service 302 connects to the Internet 312, and can be accessed by users also connected to the Internet. Connections and capabilities include, but are not limited to, those discussed previously, such as ISPs, personal computers, and mail gateways that include permanent mailboxes.

A user accesses online service 302 using a browser on his personal computer 314, which is also connected to the Internet 312 via a modem 316. The browser allows the user to contact servers at online service 302. The user registers with online service 302 by providing information such as name, address, billing information if appropriate, and permanent e-mail address. The user can also access his temporary e-mail mailbox from an arbitrary computer 318.

The SMS 314 then manages the user's interaction with the site; it controls and optionally limits access. The SMS also enables a user to configure a temporary mailbox 310, allowing other registered users to send e-mail through the online service, or optionally allowing arbitrary e-mail through mail server 306. The user uses POP server 308 to access email in temporary mailbox 310.

The temporary mailbox service provides a temporary address and optionally a temporary screen name. The user also can specify a time period for the temporary mailbox to be valid. The service provider configures the temporary mailbox. In a preferred embodiment, the user can customize his temporary address; alternatively, the service can provide it. In a preferred embodiment, the online service utilizes a translation table that associates a temporary address with contact information.

Once set up, the user's contact information is automatically represented with the temporary address. In alternatives, a user can manage complex interactions and transactions. For example, imagine someone who uses an on-line auction site sporadically to sell items, to pursue an on-going interest in collecting baseball cards, and to make a one-time purchase of an automobile. This user could have one very short-term temporary mailbox to track automobile auctions; a second long-term mailbox to manage buying and selling baseball cards; and additional temporary mailboxes with time periods that suit particular uses.

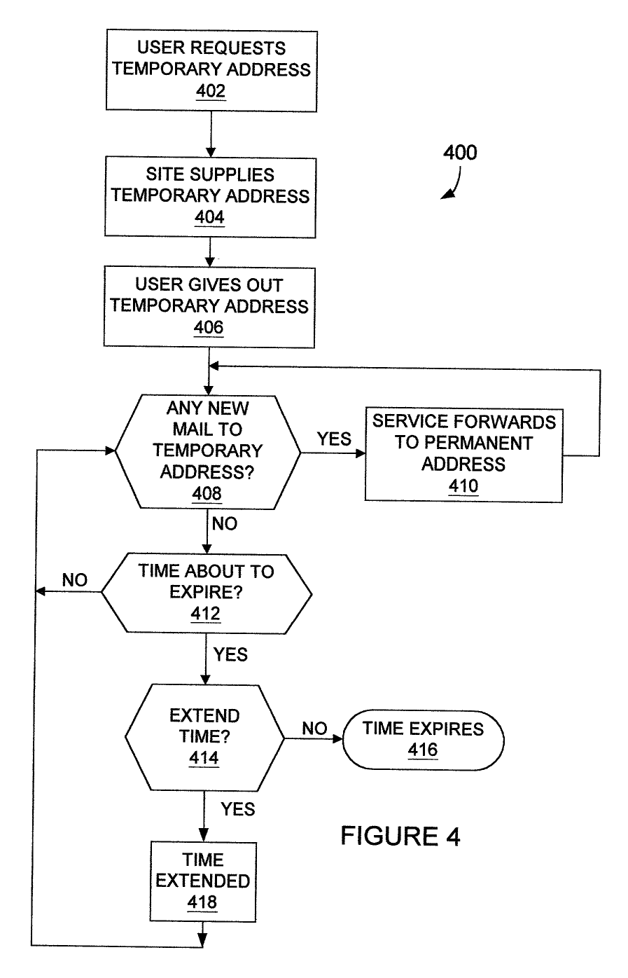

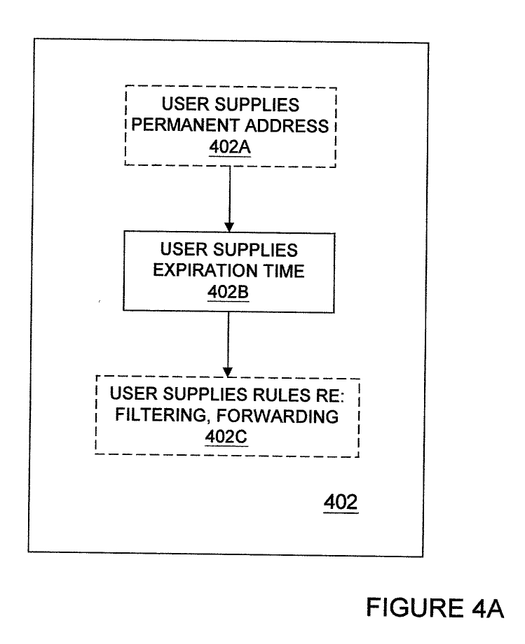

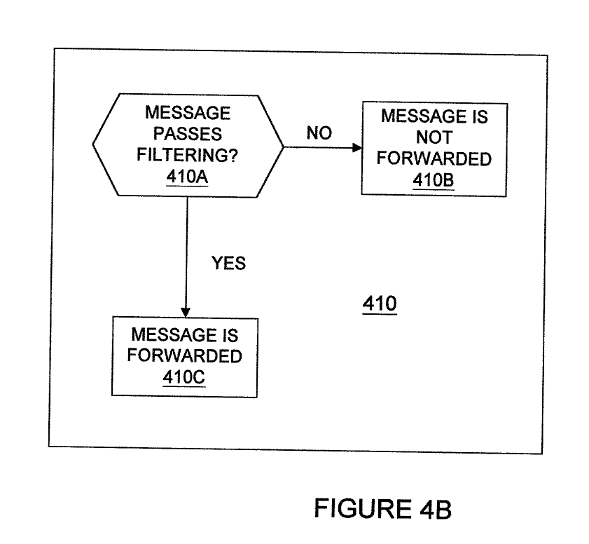

A method 400 of the invention is shown in FIG. 4. At step 402, a user requests a temporary address from a supplier. The supplier can be, for example, an Internet service provider (ISP) or a website. At step 404, the site supplies a temporary address. As has been discussed, the address can be given to the user by the site or can have various degrees of user selection.

At step 406, the user gives out the temporary address. This can be through the Internet; for example, the temporary address can be presented as the user's contact information. At step 408, the method checks whether there is any new e-mail to the temporary address. If yes, the service (typically the web site or ISP) forwards the mail to the user's permanent address, at step 410. In an alternative, the user can access the mail through the service using a POP or other mail server at the service. In that case, the user reads the mail directly from the temporary mailbox instead of having it forwarded to his permanent mailbox.

If there is no new mail to the temporary address, the method continues to step 412 and checks whether the length of time for which the user has activated the temporary mailbox is about to expire. If the time is not about to expire, the method loops back to step 408 and continues to check whether there is new mail to the temporary address.

If the time is about to expire, the method proceeds to step 414, where it is decided whether to extend the time. The service can send the user e-mail to inquire whether he chooses to extend the temporary mailbox. If it is decided not to extend the time, the method proceeds to step 416, the time expires, and the temporary mailbox is no longer operative.

If it is selected to extend the time, the method proceeds to step 418, where the time is extended, then loops back to check for mail to the temporary address at step 408, and proceeds from there.

FIGS. 4A and 4B depict substeps of method 400. FIG. 4A shows substeps of step 402, the user requesting a temporary address. At an optional substep 402A, the user supplies his permanent address so that the service can forward mail from the temporary mailbox. (In alternatives, the user accesses the temporary mailbox directly and the mail is not forwarded.) At step 402B, the user supplies an expiration time for the temporary mailbox, or equivalently, specifies an interval for which the temporary mailbox will be active. At optional step 402C, the user supplies rules for filtering or forwarding. For example, the user could specify that only mail containing a particular keyword or re line (for example, a purchase price threshold), or only mail that meets a time deadline, be forwarded and that mail not meeting the conditions be retained in the temporary mailbox but not forwarded, or that it be deleted or forwarded to a different address. The optional substeps are depicted in dashed lines.

FIG. 4B depicts substeps of step 410. At a step 410A, the method inquires whether the message passes filtering. If no, at step 4101B the message is not forwarded (it can be saved in the temporary mailbox, diverted to another mailbox, or deleted). If the message passes filtering, the method proceeds to substep 410C, and the message is forwarded.

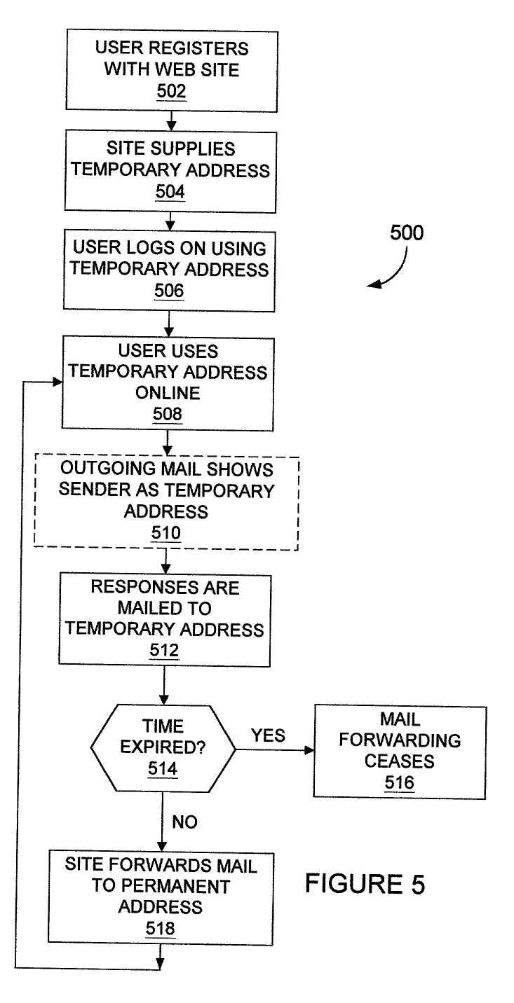

A method 500 in accordance with the present invention is depicted in FIG. 5. FIG. 5 is directed to an instance where an on-line service manages the temporary mailbox.

A user registers with the web site 502. At a step 504, the site supplies a temporary address. The method proceeds to step 506, where the user logs on using the temporary address. At a step 508, the user uses the temporary address online.

The method then optionally proceeds to step 510, in which outgoing mail and on-line message posts show the temporary address. The method then proceeds to step 512, in which responses to the user's use of the temporary address are sent to the temporary address (as it is the only address known from the activities). The method then proceeds to step 514, where it is determined whether the time has expired. If the time has expired, the method proceeds to step 516, and the temporary mailbox is terminated.

If the time has not expired, the method proceeds to step 518, and the site forwards mail to the user's permanent address. Alternatively, the mail can be retained in the temporary mailbox for the user to pick up, or can be forwarded to another address, or can be subjected to a filter (e.g., certain responses can be treated differently). After step 518, the method loops back to step 508 and proceeds from there.

Other technologies and configurations are known. The system can include a mail gateway. The connections can be wireless. The system can be combined with voicemail systems to pick up messages via telephone or other than via computer. The term “web site” is used in describing apparatus and method examples of the invention. “Web site” should be understood to refer to any network-attached computer that provides services. The compatibility of the invention with the use of other components and systems will be known to those skilled in the art. Those skilled in the art will be aware of numerous variations within the bounds of the invention, the scope of which is limited only by the following claims.

What is claimed is:

1. A method for establishing a temporary e-mail address comprising the following steps:
a user requesting a temporary address from an internet web site;
the web site providing a temporary address;
the user publicizing the temporary address to at least one correspondent;
the user selecting a time period for which the temporary e-mail address will remain valid;
a server at the web site checking whether there is mail to the temporary address;
if there is mail, the server forwarding it to the user's permanent email address if and only if the time period has not expired.

2. The method of claim 1 wherein the user can elect to extend the time period.

3. The method of claim 1 wherein the user can access the temporary mailbox directly.

4. The method of claim 1 in which the user can provide filtering criteria so that only mail that meets said criteria will be forwarded.

5. A system for establishing a temporary e-mail address for correspondence via the internet, comprising the following:
a sending computer;
a recipient computer;
a mail server; and
a temporary mailbox established by a user to remain operational for a predetermined duration;
wherein an electronic message from the sending computer mailed to the temporary mailbox within the predetermined duration will be stored there, and further wherein the user can access the temporary mailbox.

6. The system of claim 5 wherein the user also has a permanent mailbox and the server forwards the stored message to the permanent mailbox.

7. A method for establishing a temporary e-mail address for correspondence via the internet, comprising the following steps:
a user who has a permanent e-mail address registering with a web site;
the web site supplying a temporary address;
an interval being specified for the temporary e-mail address;
the user logging on using the temporary address;
the user using the temporary address online;
responses being sent to the temporary address;
the web site forwarding said responses to the permanent address if and only if the interval has not expired.

8. The method of claim 7 wherein the user specifies the interval.

9. The method of claim 8 wherein the website specifies the interval.

10. The method of claim 7 wherein the interval can be extended.

11. The method of claim 7 in which the user can provide filtering criteria so that only mail that meets said criteria will be forwarded.
